(19) United States
(12) Patent Application Publication
(10) Pub. No.: US 2026/0266749 A1
(43) Pub. Date: Sep. 10, 2026

(54) NANOSCALE THERMOMETRY FOR LATENT HEAT MEASUREMENT

(71) Applicant: University of Virginia Patent Foundation, Charlottesville, VA (US)

(72) Inventors: Thomas W. Pfeifer, Knoxville, TN (US); Sara H. Makarem, Charlottesville, VA (US); Patrick E. Hopkins, Charlottesville, VA (US)

(21) Appl. No.: 19/489,171

(22) PCT Filed: May 31, 2024
(86) PCT No.: PCT/US2024/032011

§ 371 Date: Dec. 1, 2025

Related U.S. Application Data
(60) Provisional application No. 63/505,458, filed on Jun. 1, 2023.

(51) Int. Cl. G01N 25/04

(52) U.S. Cl. CPC G01N 25/04

(57) ABSTRACT

Characterizing the latent heat of fusion of a sample material can involve irradiating the sample material with laser light generated by a first laser, which includes elevating the temperature of the material to induce a phase transition between solid and liquid states. The method can also include measuring a property of the sample material during thermal arrests, which occur when the material transitions between these states. The composition of the sample material can be determined, e.g., by utilizing values corresponding to the amount of energy delivered to the sample material by the laser light and the properties measured during the thermal arrests.

### CLAIM OF PRIORITY

This application claims the benefit of priority of Pfeifer et al., U.S. Provisional Patent Application No. 63/505,458, titled “NANOSCALE THERMOMETRY TECHNIQUE FOR THE MEASUREMENT OF ENTHALPY OF MELTING,” filed on Jun. 1, 2023 (Attorney Docket HOPKINS-MELT (02941-01)), which is incorporated by reference herein in its entirety.

This invention was made with government support under DE-EE0009157 awarded by the Department of Energy. The government has certain rights in the invention.

### BACKGROUND

Thermal properties of a material can be measured, such as for characterization or identification of a metal, compound, or alloy. Different materials and their associated phase transitions generally have different thermal properties, such as thermal conductivity or specific heat as illustrative examples. Various thermal and spectroscopic analysis techniques may be used to measure thermal properties of an unknown or complex material to assist in characterizing such a material.

### BRIEF DESCRIPTION OF THE DRAWINGS

In the drawings, which are not necessarily drawn to scale, like numerals can describe similar components in different views. Like numerals having different letter suffixes can represent different instances of similar components. The drawings illustrate generally, by way of example, but not by way of limitation, various embodiments discussed in the present document.

FIG. 1A is a diagram showing an example of a portion of a Differential Scanning Calorimetry (DSC) apparatus.

FIG. 1B is a chart showing a relationship between energy applied to a sample material and temperature of the temperature material, corresponding with the Differential Scanning Calorimetry (DSC) apparatus of FIG. 1A.

FIG. 2A schematically depicts an example of a thermoreflectance portion of a apparatus for characterization of latent heat of a phase change of a sample material.

FIG. 2B depicts an example of an infrared pyrometry portion of a apparatus for characterization of latent heat of a phase change of a sample material.

FIG. 3A is a chart showing a relationship between temperature and energy applied to a sample material, corresponding with a thermoreflectance apparatus or an infrared pyrometry apparatus.

FIG. 3B is a chart showing a temperature over time during a phase change of Tungsten (W).

FIG. 4A is chart showing a thermal model for determining a composition of the sample material, using at least one of a value corresponding to an amount of energy delivered to the sample material by the laser light or the measured property of the sample material.

FIG. 4B is chart showing a thermal model for determining a composition of the sample material, using at least one of a value corresponding to an amount of energy delivered to the sample material by the laser light or the measured property of the sample material.

FIG. 4C is a graphical representation of an example of a thermal model for determining an enthalpy of fusion of a sample material.

FIG. 5 is a chart depicting a comparison of the thermal model described in FIG. 4A and FIG. 4B against an analytical model.

FIG. 6 is a chart showing a thermal signature of the resolidification of paraffin, exhibited during an example of a thermoreflectance technique.

FIG. 7A is a chart showing a thermal signature of the resolidification of tungsten (W) exhibited during an example of a pyrometry technique.

FIG. 7B is a magnified view of the chart of FIG. 7A.

FIG. 7C is a chart showing a thermal signature of the resolidification of molybdenum (Mo) exhibited during an example of a pyrometry technique.

FIG. 7D is a magnified view of the chart in FIG. 7C.

FIG. 8 is a flowchart describing an approach for characterization of latent heat of a phase change of a sample material.

FIG. 9 illustrates generally a block diagram of a machine upon which any one or more of the techniques (e.g., methodologies) discussed herein may be performed.

### DETAILED DESCRIPTION

This document relates to the measurement of thermal properties of materials, and more specifically to the characterization of materials via observed thermal properties during a phase change of the material. For example, a material (e.g., a metal, compound, etc.) can exhibit thermal properties that are specific to or associated with particular phase transitions, e.g., such as latent heat of fusion. For purposes of analysis, a material phase change process can be modeled as “reversible.” Other examples of thermal properties, such as associated with other types of phase transitions, can include latent heat of vaporization, latent heat of melting and latent heat of sublimation. Changes in thermal energy (“enthalpy”) such as associated with a phase change can affect measurable physical characteristic of a material. For example, various materials can exhibit distinctive temperature profiles associated with phase changes, including distinctive peaks, curvature, turn points on a temperature scale, discontinuities, or other changing patterns indicating that a phase change is incipient, occurring, or complete. The characterization of thermal properties during a phase change can be used for various applications, including material identification, selection, optimization of thermal management systems, evaluation of energy storage and transfer capabilities, and understanding of material behavior under different conditions.

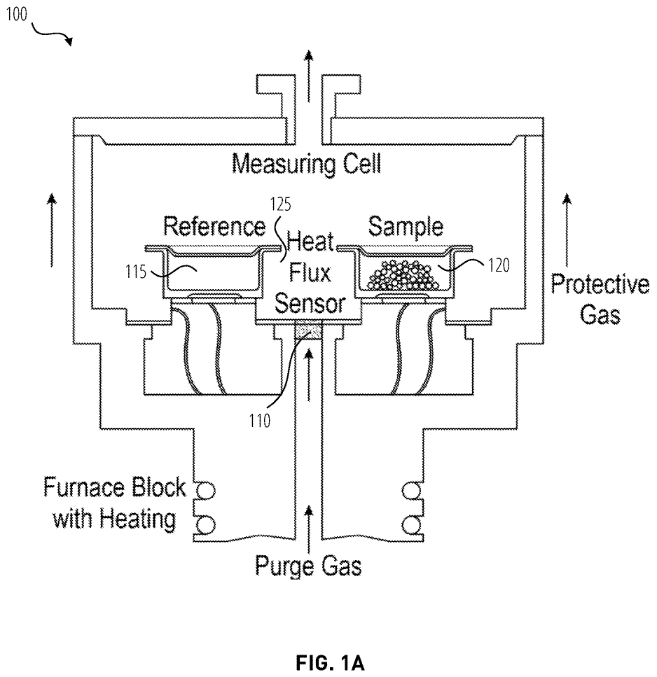

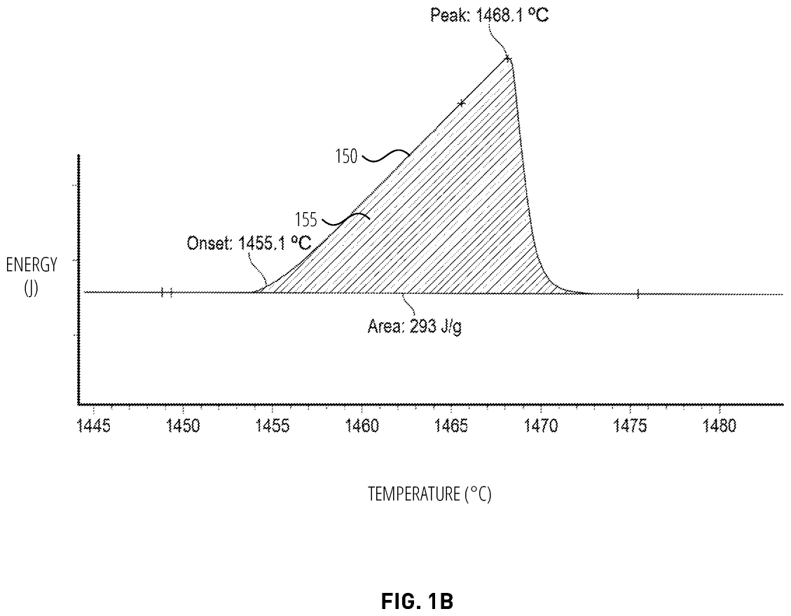

One approach to measuring thermal properties during of a phase change material (PCM) can involve using Differential Scanning Calorimetry. For example, FIG. 1A is a diagram showing an example of a portion of a Differential Scanning Calorimetry (DSC) apparatus and FIG. 1B is a chart showing a relationship between energy applied to a sample material and temperature of the sample material, such as can be obtained using the Differential Scanning Calorimetry (DSC) apparatus 100 of FIG. 1A. Generally, a DSC apparatus 100 can be configured for measuring the heat flow or energy differences between a sample and a reference material as a function of temperature. For example, the DSC apparatus 100 can include a heater 110, a reference material vessel 115, a sample material vessel 120, and a heat flux sensor 125. In operation, a material sample can be obtained and placed into the sample material vessel 120, while another material (reference material) can be placed into the reference material vessel 115. Alternatively, the chamber for holding the reference material can instead be left empty in certain applications. The heater 110, such as an electrically-driven heating coil, can heat the material vessels 115 and 120 in a controlled manner, and the temperature changes during the process can be recorded by the heat flux sensor 125. The output associated with one or both of the measurement of the actual sample temperature, for example the energy utilized to heat the sample and associated heat lost through the heat sink structure, and detected output from the temperature sensor as a function of the time period, can be related to an “actual” power transmitted to the sample to heat it, e.g., less the amount of heat lost or tapped off for measurement. Thus, based on known reference materials to calibrate the thermal properties of the system, a measured material sample can be analyzed based on size, shape, and thermal properties.

In an example, as shown in FIG. 1B, a DSC curve 150 can reflect the changes in the energy of a sample material, such as a solid material, as a function of the temperature changes. For example, a measured area 155 under the DSC curve 150 can be distinctive or otherwise characteristic of a mass of a sample material. Certain DSC approaches can rely on an availability of bulk quantities (e.g., greater than 20 milligrams (mg)) of the sample material and may be unsuitable to be implemented for analysis involving microscale, nanoscale, or submicron structures such as films. Macro-scale DSC may be unsuitable or even unusable for structures having micro-scale or nano-scale mass, such as comprising nanograms or microgram masses of material. For example, working with very small amounts of material may present a challenge to manipulation of the material sample and precise, consistent control of the sample or reference thermal paths, e.g., through the reference and sample vessels embodied in the DSC apparatus 100.

The present inventors have developed, among other things, a pyrometry technique suitable for micro-scale or nano-scale material characterization. This technique can include use of a first laser (e.g., a high-power laser) to help induce a phase change in a PCM. Such a laser can be focused toward a relatively small (e.g., approximately micron-sized) spot on the sample, which can be elevated in temperature and subsequently melted. For example, by measuring a time-varying temperature waveform, the thermal arrest due to melting or resolidification can be determined, and a thermal model (e.g., capturing heating, melt pool formation and growth, or subsequent melt heating) can be used for estimation of an enthalpy of melting associated with the phase change. Alternatively or additionally, changes in temperature (e.g., induced by irradiation, thermal conductivity, or radiative cooling) can be monitored via a second laser in using thermoreflectance, e.g., time-domain thermoreflectance, (TDTR) frequency-domain thermoreflectance, (FDTR) or steady-state thermoreflectance, (SSTR), as illustrative examples. Alternatively or additionally, the changes in temperature can be measured via one or more pyrometer apparatus. The shape of acquired time-series data as measured, such as via a photodiode or other sensor, can provide an indication of specific properties of the material, e.g., a distinctive “signature” by which an unknown sample material can be classified. For example, a time-series depict heating or cooling, or cycles thereof, such as acquired using a thermoreflectance technique.

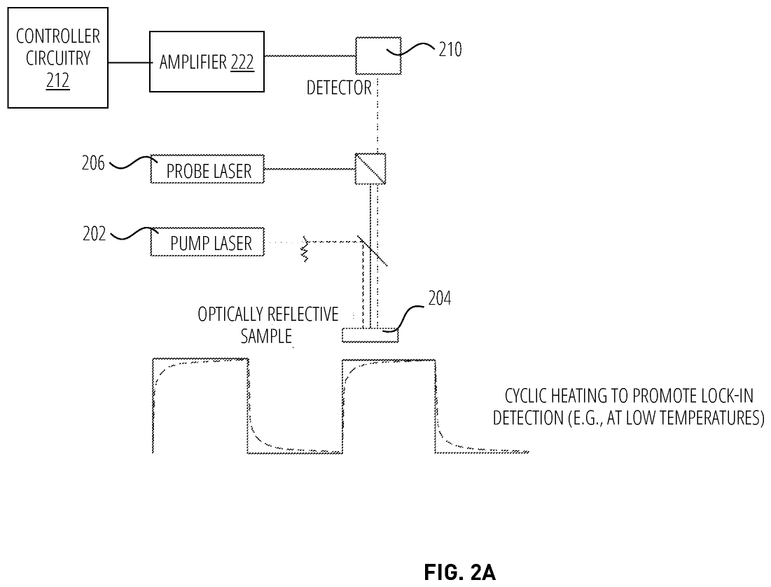

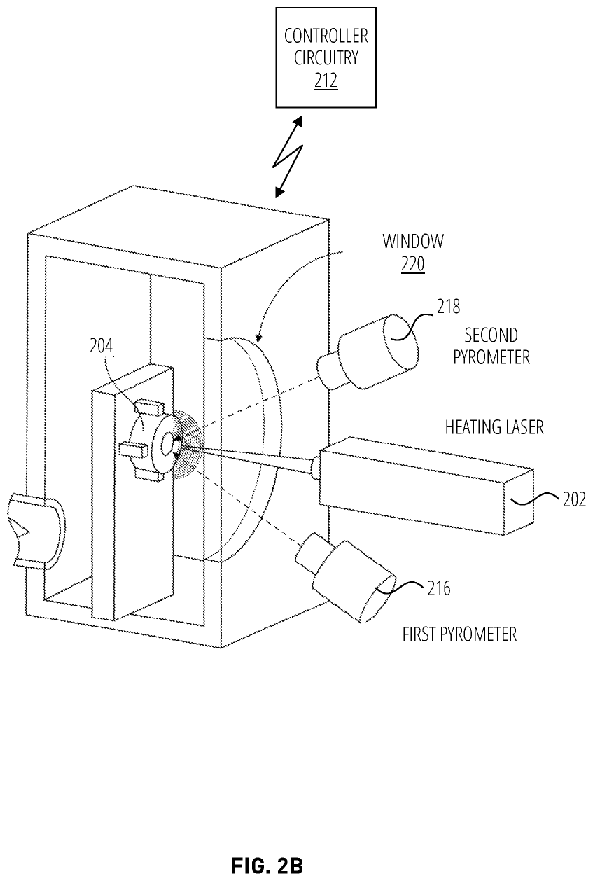

FIG. 2A and FIG. 2B each depict a portion of an example of a system for characterization of latent heat of a phase change of a sample material. FIG. 2A schematically depicts an example of a thermoreflectance portion 200A, and FIG. 2B depicts an example of an infrared pyrometry portion 200B. The apparatus for characterization of latent heat of a phase change of a sample material can include at least one of the portion 200A and the portion 200B, such as both portion 200A and portion 200B. As such, the apparatus for characterization of latent heat of fusion can include several combinations of components, such as a first laser 202, a second laser 206, a third laser 208, a detector 210, controller circuitry 212, an enclosure 214, a first pyrometer 216, a second pyrometer 218, a window 220, an amplifier 222, or other aspects described with respect to portions 200A and 200B.

As shown in FIG. 2A, the portion 200A can include or use a first laser 202 arranged to heat a sample material 204, such as to facilitate a phase transition between, e.g., solid and liquid states. In an example, such as in a thermoreflectance application as shown in portion 200A, the first laser 202 can include a pump laser capable of providing laser light for irradiation at a power between about 25 milliwatts (mW) and about 500 mW. For example, the first laser 202 can be capable of providing laser light for irradiation at a power between 50 milliwatts (mW) and about 5 Watts (W), such as at about 100 mW. The first laser 202 can also be configured for providing laser light for irradiation at a power lower than 50 mW, such as at less than 40 mW, less than 30 mW, less than 20 mW, or less than 10 mW. Here, the first laser 202 can be arranged such as to irradiate a sample material 204, e.g., placed within a sample holder of the portion 200A. In an example, the portion 200A can include or use one or more mirrors arranged to direct laser light from the first laser 202 toward the sample material 204. In an example, the first laser 202 can emit laser light toward sample holder via a focused beam with a beam radius of less than about 50 μm, such as less than about 40 μm, about 30 μm, about 20 μm, about 10 μm, about 5 μm, such as at a beam radius of about 3 μm. In an example, the first laser 202 can emit laser light toward the sample holder at a wavelength between about 600 nanometers (nm) and about 700 nm, such as at a wavelength of about 637 nm. In an example, the portion 200A can facilitate heating of the sample material 204, via the first laser 202, at a temperature less than 500 Kelvin (K), such as less than 400 K or less than 300 K.

In an example, the portion 200A can include or use the second laser 206. The second laser 206 can be similarly arranged (e.g., including one or more mirrors to divert laser light) to direct a beam toward a sample material 204 disposed within the sample holder of the portion 200A. The second laser 206 can include a probe laser capable of providing laser light for irradiation at a power between about 25 milliwatts (mW) and about 500 mW. For example, the second laser 202 can be capable of providing laser light for irradiation at a power between 50 milliwatts (mW) and about 200 mW, such as at about 70 mW. In an example, the second laser 206 can emit laser light toward sample holder via a focused beam with a beam radius of less than about 50 μm, such as less than about 40 μm, about 30 μm, about 20 μm, about 10 μm, about 5 μm, such as at a beam radius of about 3 μm. In an example, the first laser 202 can emit laser light toward the sample holder at a wavelength between about 700 nanometers (nm) and about 800 nm, such as at a wavelength of about 785 nm.

In an example, the first laser 202 can be activated to irradiate the sample material 204, e.g., tens or hundreds of degrees and to induce a phase change of the sample material 104. In an example, portion 200A can not directly measure a temperature of the sample material 204 during the irradiation. Instead, a reflectance of a beam of the second laser 206 can be measured such as to monitor temperature changes of the sample material 204 caused by the first laser 202. For example, the thermoreflectance portion 200A can include a detector 210 to receive at least a portion of the laser light emitted by the second laser 206 after it has been reflected off the sample material 204 or an optically reflective surface covering the sample material 204. The detector 210 can include a suitable photodetector for sensing changes in intensity of the light (e.g., the beam of the second laser 206), due to reflectance changes caused by heating (at the sample material 204) or phase changes within the sample material 204. The detector 210 can be arranged or integrated with one or more monochromators, filters, lenses, or similar apparatus to facilitate detection of specific frequencies or wavelength of light such as for data sampling and analysis. In an example, as the sample material 204 is heated during irradiation with the first laser 202, a shift in absorbance (or reflectance) causing changes can be detected using the second laser 206 as a probe light. The detector 210 can detect optical signals from the reflected second laser beam and generate related electrical signals indicative of the detected signal.

In an example, the detector 210 can be communicatively coupled to an amplifier. For example, the amplifier 222 can include a lock-in amplifier, e.g., for amplifying the higher order harmonics of the detected signal, then coupled to controller circuitry 212, e.g., including our coupled to one or more digital to analog converters for generating data indicative of the detected signal. For example, at least one of the amplifier 222 or the controller circuitry 212 can be configured to perform a periodic waveform analyzer (PWA) operation, e.g., to extract one or more temperature dependent properties of the sample material, such as an electronic energy. The amplifier 222 can amplify signals and drive the processor 212 such as to generate digitized data indicative of a thermoreflectance signal from the detector 210.

In an example, for incremental heating by the first laser 202, the second laser 206 can be acting as a temperature probe and the controller circuitry 212 can be configured to generate numerical data, where the numerical data is indicative of a temperature at which the sample material undergoes a phase change. In an example, this temperature can be related to, e.g., enthalpy effects, free energy effects, melting effects, thermal hysteresis effects, oxidative effects, and so on. The processor 212 can be configured for implementing a numerical computation, a digital solver, or lookup table determinations, as illustrative example. The controller circuitry 212 can include an analog to digital converter, gating electronics, and one or more processors for generating data (e.g., data indicative of the reflected beam absorbance) that is indicative of electronic temperature properties of the sample material. In an example, the controller circuitry 212 can control the first laser 202 such as to provide cyclic (e.g., approximately square wave or approximately sine wave) heating of the sample material 204 such as to promote sensing and detection via at least the lock-in amplifier 222. For example, a first laser 202 can have a lock-in reference frequency that is established by the controller circuitry 212 to modulate a temperature of the sample at its electronic structure. In an example, with respect to portion 200A, the system controller 112 can provide relatively fast envelope modulation (e.g., about 100 hertz (Hz) to about 10,000 Hz) of laser light from the first laser 202, can prevent PCM from reaching fully molten or fully solid states. For example, the first laser 202 can be modulated at frequencies achieving both of the following: a) the modulation is not so fast as to prevent the sample from reaching fully molten or solid states and b) the modulation is sufficiently high as to yield a time-dependent signal with an acceptably low level of noise. In an example, the portion 200A can be configured to overcome certain challenges which can be generally related to thermoreflectance. For example, it can be important in that a surface of the sample material 204 is or remains optically reflective during molten state of a particular material under test. For example, the portion 200A can include an optically reflective surface covering for providing an optically reflective surface over the sample material 204. The optically reflective surface covering can be formed of a translucent material such as glass, sapphire, quartz, certain plastics, etc., which allows laser light or other infrared radiation to pass through. The optically reflective surface can be provided via a glass vessel, a phase change material (PCM), or aluminum disposed between a glass slide and the PCM.

In an example, the thermoreflectance portion 200A can further include a third laser. The third laser can include a supplementary probe laser capable of providing laser light (e.g., at or near the same target location as the laser light provided by the first laser 202) for irradiation at a power between about 500 milliwatts (mW) and about 10 Watts. For example, the second laser 202 can be capable of providing laser light for irradiation at a power between 800 milliwatts (mW) and about 8 mW, such as at about 5 mW. In an example, the third laser can emit laser light toward sample holder via a focused beam with a beam radius of less than about 50 μm, such as less than about 40 μm, about 30 μm, about 20 μm, or about 10 μm, such as at a beam radius of about 5 μm. In an example, the first laser 202 can emit laser light toward the sample holder at a wavelength between about 400 nanometers (nm) and about 600 nm, such as at a wavelength of about 520 nm., such as a supplementary (e.g., free-space) pump laser. In an example, components of the apparatus 200A (e.g., the first laser 202, the second laser 206, the third laser 208, the detector 210, or the controller circuitry 212,) can be included in a steady state thermoreflectance (SSTR) system.

As shown in FIG. 2B, the portion 200B can include or use a first pyrometer 216 and a second pyrometer 218 to detect temperature changes of a sample material 204 before, during, and after a phase change initiated by the first laser 202 in portion 200A. In other words, the pyrometry portion 200B can or can be configured to detect temperature changes at the same target location as at which the sample material 204 is irradiated by the first laser 202. In an example, the first pyrometer 216 and the second pyrometer 218 can be configured to detect infrared radiation emitted by the sample material 204 as the sample material 204 undergoes, e.g., melting, solidification, chemical alteration, growth, corrosion, dissolution, decomposition, distillation, sublimation or similar processes. In an example, at least one of the first pyrometer 216 or the second pyrometer 218 can be configured to detect IR radiation between about 3 μm and about 20 μm wavelength, e.g., between about 7 μm and about 20 μm, or between about 2 μm and about 5 μm wavelength, e.g., between about 3 μm and about 13 μm, or between about 10 μm and about 13 μm, in an example between about 2 μm and about 5 μm, or between about 3 μm and about 13 μm wavelength. In an example, the first and second pyrometers 216 and 218 can each include or use an infrared (IR) camera or a radiation temperature detector such as a digital infrared imaging or thermal IR imaging sensor infrared imaging chip with one or more readout integrated circuits (ROIC). For example, the IR camera can include a detector array configured to detect electromagnetic radiation in at least one or more of a wideband (e.g., white/warm, red afferent, or violet/green/blue), a short band (e.g., visible), a middle band (e.g., UV, NIR, SWIR, MWIR, or FIR), or a long band (e.g., seismic, radar, microwave, PLC, or GF) spectral range.

In an example, with respect to portion 200B as depicted in FIG. 2B, the first laser 202 can be arranged to heat a sample material 204, such as to facilitate a phase transition between, e.g., solid and liquid states. In an example, such as in a pyrometry application as shown in portion 200B, the first laser 202 can include a pump laser capable of providing laser light for irradiation at a power between about 100 W and 100 (kW) kW. For example, the first laser 202 can be capable of providing laser light for irradiation at a power between 500 W and about 10 kW, between 1 kW and about 5 kW, such as at about 2 kW, 3 kW, or 4 kW. The first laser 202 can also be configured for providing laser light for irradiation at a power higher than 100 kW, such as at greater than 200 kW, greater than 300 kW, greater than 400 kW, or greater than 500 kW. Here, the first laser 202 can be arranged such as to irradiate a sample material 204, e.g., disposed within a sample holder of the portion 200B. In an example, the portion 200B can facilitate heating of the sample material 204, via the first laser 202, at a temperature greater than about 500 Kelvin (K), such as between about 500 K to about 5000 K, between about 1000 K and about 4000 K, such as about 2000 K, about 3000 K, or about 4000 K.

In an example, the portion 200B can include or be communicatively coupled with the controller circuitry 212. The controller circuitry 212 can receive data indicative of IR radiation detected by at least one of the pyrometers 216 and 218 and analyze the data indicative of the IR radiation emitted by the sample material to determine temperature changes of the sample material. In an example the controller circuitry 212 can be configured or designed to compute a phase change in the sample material based on a detected changes in IR radiation from the pyrometers 216 or 218. In an example, the temperature data can be measured using the pyrometers 216 and 218 at or near the extract target location for illumination by the first laser 202. For example, the first pyrometer 216 may be used to detect changes in energy of electromagnetic radiation emitted by the sample material 204 due to changes in electronic structure when the sample material is excited by the first laser 202, while the second pyrometer 218 can be used to observe or monitor changes in temperature. For example, based on the detected radiated energy from the sample material, a first ratio may be measured to changes during and after the phase change initiated by the first laser 202, wherein changes in the first ratio can correspond to phase changes of the sample material. Here, the processor circuitry can analyze the data collected by the first pyrometer 216 and the second pyrometer 218 to determine a latent heat associated with a phase change of the sample material 204.

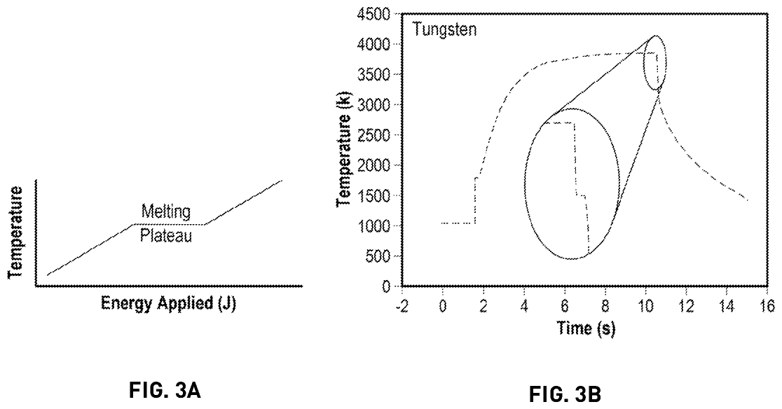

FIG. 3A is a chart showing a relationship between temperature and energy applied to a sample material, corresponding with a thermoreflectance apparatus or an infrared pyrometry apparatus. The controller circuitry 212 of FIG. 2A and FIG. 2B can facilitate measuring of specific properties of the material during “thermal arrests”, which are critical periods when the material changes from solid to liquid or vice versa and can manifest as a plateau on a plot of material temperature per energy applied to the material. Operation of a apparatus for characterization of latent heat of a phase change of a sample material can involve such thermal arrests during heating or cooling which can indicate melting or resolidification, respectively. For example, a relative size of “plateau” can indicate a latent heat of melting or other phase transformation. In an example, the plateau can be indicative of other “units” of material, not just for homogenous material systems in thermal equilibrium. For example, FIG. 3B is a chart showing exhibiting a thermal arrest, indicated by a plateau, for a phase change of Tungsten (W).

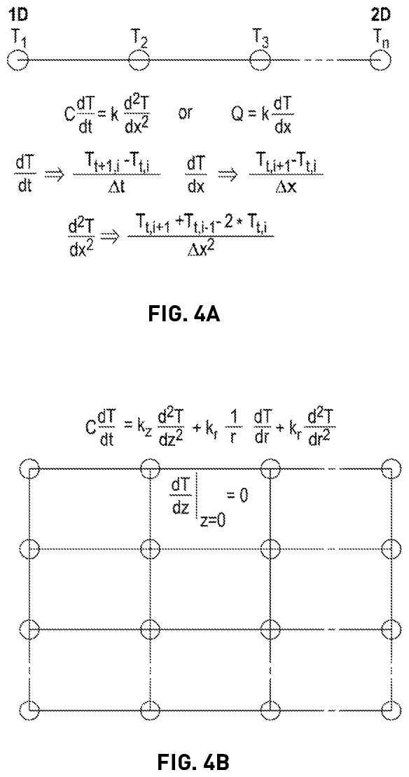

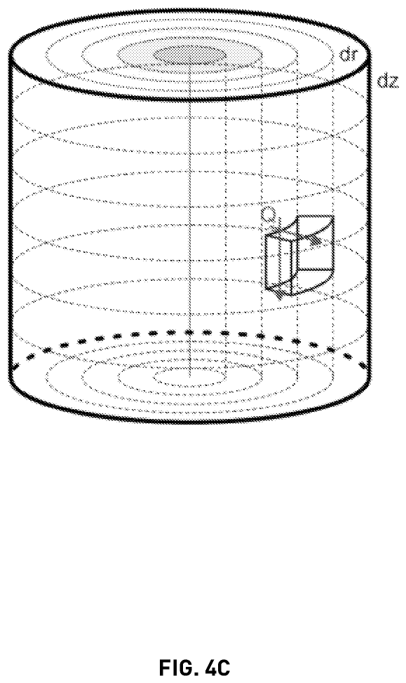

FIG. 4A and FIG. 4B are charts showing a thermal model for determining a composition of the sample material, using at least one of a value corresponding to an amount of energy delivered to the sample material by the laser light or the measured property of the sample material. FIG. 4A and FIG. 4B relate to 1D and 2D axisymmetric models, respectively. In an example, a thermoreflectance system can not be in thermal equilibrium (e.g., related to melt pool to change size during the simulation). As such, simply looking at a net heat (as in certain DSC techniques) can be insufficient for obtaining desired measurements. In an example, the controller circuitry 212 can facilitate determining an enthalpy of fusion of the sample material according to a thermal model for the heating/melting/cooling of a specified material.

In an example, where the apparatus includes a thermoreflectance portion (e.g., portion 200A as described in FIG. 2A), the controller circuitry 212 can track energy consumed by melting (or released by solidification). For example, at each timestep, Tₜ₊₁ can be calculated. Where Tt+1>T_{Melt} and melted ≠100%, an energy consumed Eₘₑₗₜ can be calculated and Tₜ₊₁ can be adjusted based on h [J/m³] and C [J/m³/K].

In an example, the controller circuitry 212 can use the thermal model to determine a melting of a sample material 204. For example, a Crank-Nicholson operation can be included or used. Such an operation can be particularly effective for certain 1D approaches (as depicted in FIG. 4A) (e.g., sans-heating). For example, inversion (or tridiagonalizing) an N*N matrix for N-nodes can be included in the method for determining melting.

Certain 2D approaches (as depicted in FIG. 4B) can involve relatively fine timesteps to help mitigate oscillations. For example, 2D CN can involve an N*M×N*M matrix for N radial and M depth nodes. In an example, timestep size involved in a stability can be orders of magnitude slower than forwards-difference.

FIG. 4C is a graphical representation of an example of a thermal model for determining an enthalpy of fusion of a sample material. In an example, the controller circuitry 212 can include or use a two dimensional (2D), axisymmetric finite difference model. For example, the model can consider a 2.5D axisymmetric system (cylindrical coordinates, discretized radially and in depth, symmetric in θ, shown in FIG. 4C) through a series of timesteps. At each timestep, the heat flux between elements can be calculated (e.g., based on the temperatures and thermal conductivities, using the cylindrical heat equation). Externally applied heat flux (e.g., via the first laser 202) can be activated, and the state (solid vs molten, or any fractional point between) can be tracked. Updated temperatures can be computed based on the net flux and the heat capacity. Where the temperature passes above or below the melting temperature, energy can be added or removed, and the tracked melt state is updated as appropriate. In another example, the controller circuitry can include or use a finite element analyzer such as COMSOL multiphysics® or other algorithmic software such as Ansys.

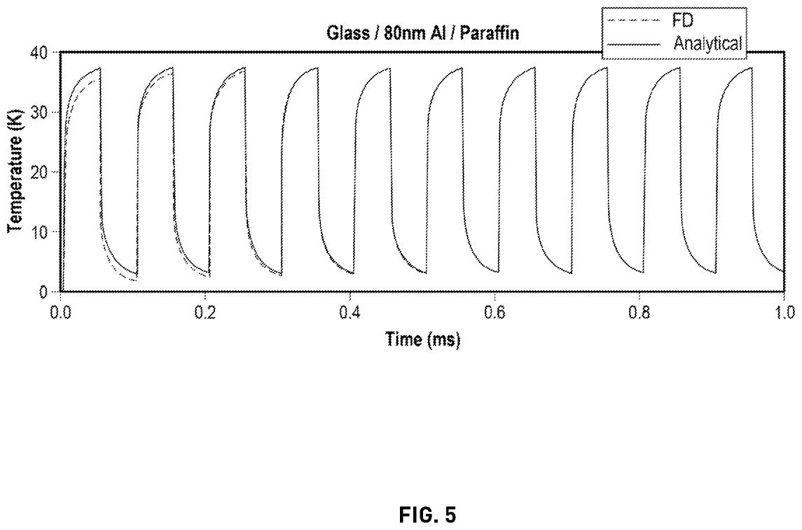

FIG. 5 is a chart depicting a comparison of the models described in FIG. 4A and FIG. 4B against analytical model, the analytical model without melting. In an example, axisymmetric models described herein can be compared with analytical models, without melting, using a COMSOL® model, e.g., including COMSOL® Multiphysics to help validate a melting code.

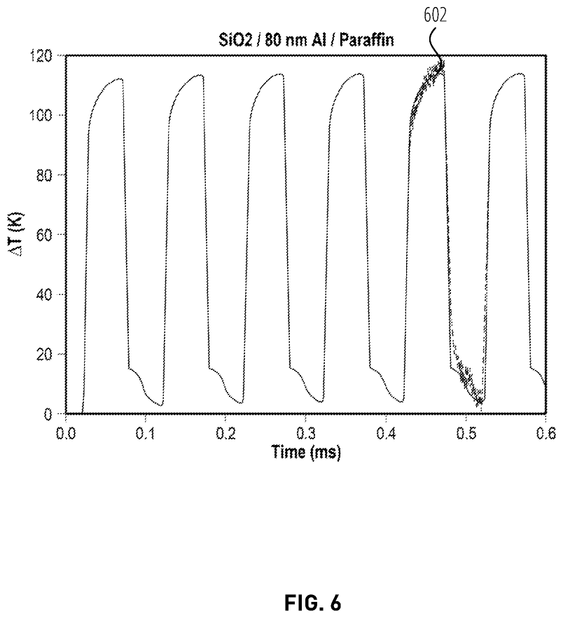

FIG. 6 is a chart showing a thermal signature of silicon dioxide (SiO₂) exhibited during an example of a thermoreflectance technique. In an example, data received from the apparatus can include the thermal signature 602, including e.g., noise, cyclic background signals to subtract off. As depicted, the model can show or otherwise indicate a melt signature. In an example, the thermal signature 602 can be distinctive from other compounds and elements under similar test.

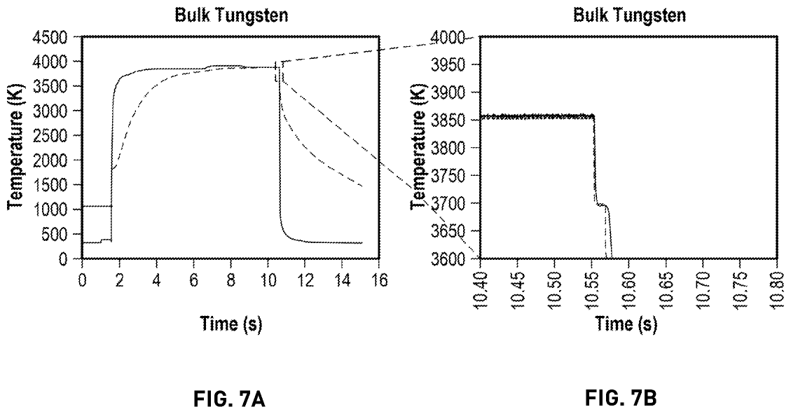

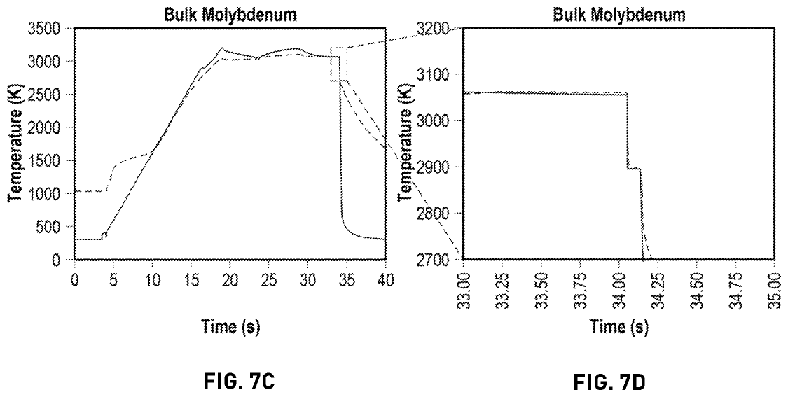

FIG. 7A is a chart showing radiative heat loss of tungsten (W) exhibited during an example of a pyrometry technique, as corresponding with in-situ conductivity of W. FIG. 7C is a chart showing radiative heat loss of molybdenum (Mo) exhibited during an example of a pyrometry technique, as corresponding with in-situ conductivity of W. FIG. 7B and FIG. 7D are magnified views of FIG. 7A and FIG. 7C, respectively. As shown on the left of FIG. 7A, certain pyrometry techniques can involve radiative heat loss. As depicted in FIG. 7A in a testing of bulk tungsten or bulk molybdenum, a hump in the plot can relate to in-situ conductivity measurements. The measurements can also include a “curvature” with a plateau on the right. In an example as depicted in FIG. 7B, a “roundness” of a stepped portion in the plot can indicate an event of overcooling. In an example, fitting a full curve can involve k_{(T)}, C_{(T)}, u_{(λ, T)}. In an example, conductivity and heat capacity can be determined using the same measurement, e.g., indicated by a hump atop the pyrometry dataset in FIG. 7B. Such plots can also be useful in determining an uncertainty analysis, e.g., where a plateau size is sensitive to spot size and instantaneous thermal conductivity.

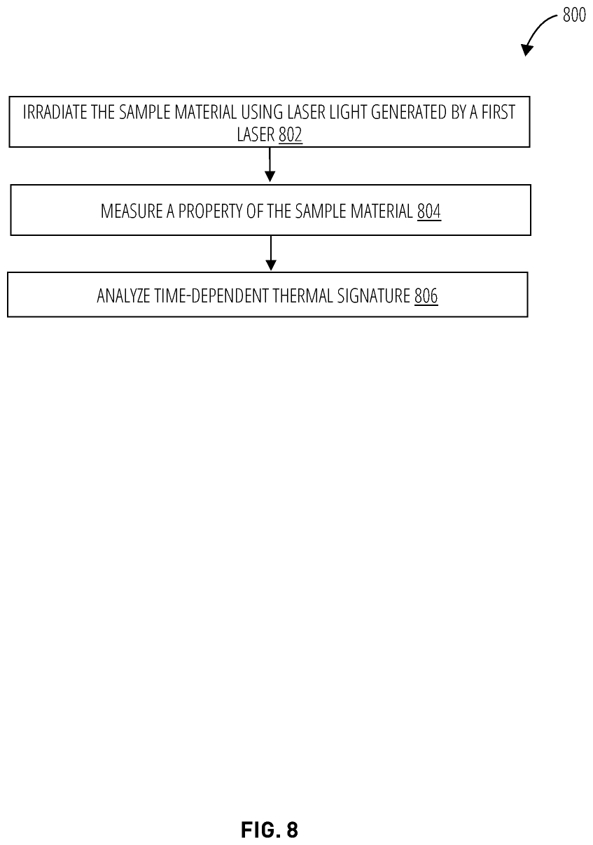

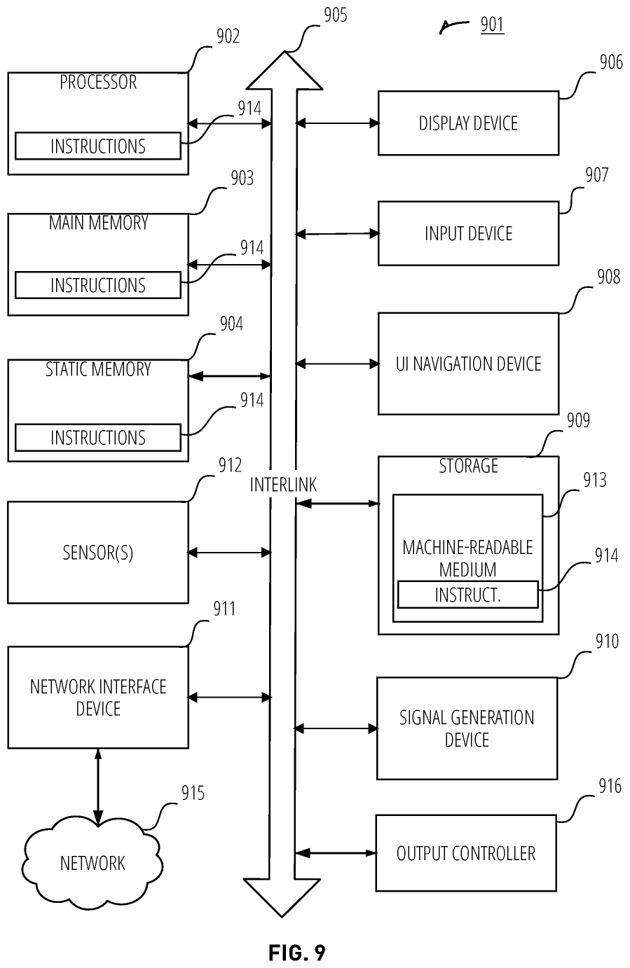

FIG. 8 is a flowchart describing a process for characterization of latent heat of a phase change of a sample material. For example, the process can be carried out via at least one of portion 200A or portion 200B of FIG. 2A and FIG. 2B, such as via the controller circuitry 212 or the processor 902 as described in FIG. 9.

At 802, process includes irradiation of a sample material using laser light generated by a first laser. Such irradiation can facilitate elevating the temperature of the material, thereby inducing a phase transition e.g., from solid to liquid state. Other phase transitions can be similarly induced, e.g., such as melting, vaporization, condensation, and solidification, depending on the material and its properties. The laser can be configured to heat the sample material toward specific temperatures, e.g., less than 500 Kelvin (such as for a thermoreflectance technique) or greater than 1000 Kelvin (such as for a pyrometry technique), depending on the sample material.

At 804, following the irradiation, one or more properties of the sample material can be measured. These properties could include changes in physical state, thermal conductivity, and other relevant thermal characteristics. The measurements can be taken both when the laser light is actively being delivered and when the laser power is off or reduced. In an example, the one or more properties of the sample material can be monitored using e.g., an infrared pyrometer and a visible-light pyrometer (e.g., for the thermorefectance technique). Alternatively or additionally, the sample material can be monitored using a second, probe laser (e.g., for the pyrometry technique). Such apparatus can provide data on the temperature of the sample material versus time, e.g., facilitating control of the temperature toward a desired level without exceeding thresholds that could e.g., damage the material. As the material undergoes a phase change, the material can exhibit a thermal arrest (e.g., exhibited in the form of a plateau in temperature of the material versus energy applied to the material). For example, the material can temporarily stabilize in a transitional phase between solid and liquid. In an example, an amount of energy delivered to the sample material by the laser light can be calculated. This calculation can be based on the duration and intensity of the laser irradiation and can be used such as to correlate the energy input with the observed changes in material properties.

At 806, using the data obtained from the measurements and the calculated energy delivery, the composition of the sample material can be determined. This can include analyzing the latent heat associated with the phase change, which can help in characterizing the material's thermal behavior. The latent heat is determined based on a temporal thermal signal and indicated by the measured properties. In an example, the data can be fed into a thermal model to help characterize the sample material.

FIG. 9 illustrates generally an example of a block diagram of a machine 901 upon which any one or more of the techniques (e.g., methodologies) discussed herein may perform in accordance with some examples. In alternative embodiments, the machine 901 may operate as a standalone apparatus or may be connected (e.g., networked) to other machines. In a networked deployment, the machine 901 may operate in the capacity of a server machine, a client machine, or both in server-client network environments. In an example, the machine 901 may act as a peer machine in peer-to-peer (P2P) (or other distributed) network environment. The machine 901 may be a personal computer (PC), a tablet PC, a set-top box (STB), a personal digital assistant (PDA), a mobile telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (Saas), other computer cluster configurations.

Examples, as described herein, may include, or may operate on, logic or a number of components, modules, or mechanisms. Modules are tangible entities (e.g., hardware) capable of performing specified operations when operating. A module includes hardware. In an example, the hardware may be specifically configured to carry out a specific operation (e.g., hardwired). In an example, the hardware may include configurable execution units (e.g., transistors, circuits, etc.) and a computer readable medium containing instructions, where the instructions configure the execution units to carry out a specific operation when in operation. The configuring may occur under the direction of the executions units or a loading mechanism. Accordingly, the execution units are communicatively coupled to the computer readable medium when the apparatus is operating. In this example, the execution units may be a member of more than one module. For example, under operation, the execution units may be configured by a first set of instructions to implement a first module at one point in time and reconfigured by a second set of instructions to implement a second module.

Machine (e.g., computer system) 901 may include a hardware processor 902 (e.g., a central processing unit (CPU), a graphics processing unit (GPU), a hardware processor core, or any combination thereof), a main memory 903 and a static memory 904, some or all of which may communicate with each other via an interlink (e.g., bus) 905. The machine 901 may further include a display unit 906, an alphanumeric input device 907 (e.g., a keyboard), and a user interface (UI) navigation device 908 (e.g., a mouse). In an example, the display unit 906, alphanumeric input device 907 and ui navigation device 908 may be a touch screen display. The machine 901 may additionally include a storage device (e.g., drive unit) 909, a signal generation device 910 (e.g., a speaker), a network interface device 911, and one or more sensors 912, such as a global positioning system (GPS) sensor, compass, accelerometer, or other sensor. The machine 901 may include an output controller 916, such as a serial (e.g., universal serial bus (USB), parallel, or other wired or wireless (e.g., infrared (IR), near field communication (NFC), etc.) connection to communicate or control one or more peripheral device (e.g., a printer, card reader, etc.).

The storage device 909 may include a machine readable medium 913 that is non-transitory on which is stored one or more sets of data structures or instructions 914 (e.g., software) embodying or utilized by any one or more of the techniques or functions described herein. The instructions 914 may also reside, completely or at least partially, within the main memory 903, within static memory 904, or within the hardware processor 902 during execution thereof by the machine 901. In an example, one or any combination of the hardware processor 902, the main memory 903, the static memory 904, or the storage device 909 may constitute machine readable media.

While the machine readable medium 913 is illustrated as a single medium, the term “machine readable medium” may include a single medium or multiple media (e.g., a centralized or distributed database, or associated caches and servers) configured to store the one or more instructions 914.

The term “machine readable medium” may include any medium that is capable of storing, encoding, or carrying instructions for execution by the machine 901 and that cause the machine 901 to perform any one or more of the techniques of the present disclosure, or that is capable of storing, encoding or carrying data structures used by or associated with such instructions. Non-limiting machine-readable medium examples may include solid-state memories, and optical and magnetic media. Specific examples of machine-readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks.

The instructions 914 may further be transmitted or received over a communications network 915 using a transmission medium via the network interface device 911 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 902.11 family of standards known as Wi-Fi®, IEEE 902.16 family of standards known as WiMax®), IEEE 902.15.4 family of standards, peer-to-peer (P2P) networks, among others. In an example, the network interface device 911 may include one or more physical jacks (e.g., Ethernet, coaxial, or phone jacks) or one or more antennas to connect to the communications network 915. In an example, the network interface device 911 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions for execution by the machine 901, and includes digital or analog communications signals or other intangible medium to facilitate communication of such software.

The above Detailed Description can include references to the accompanying drawings, which form a part of the detailed description. The drawings show, by way of illustration, specific embodiments in which the invention can be practiced. These embodiments are also referred to herein as “examples.” Such examples can include elements in addition to those shown or described. However, the present inventors also contemplate examples in which only those elements shown or described are provided. Moreover, the present inventors also contemplate examples using any combination or permutation of those elements shown or described (or one or more aspects thereof), either with respect to a particular example (or one or more aspects thereof), or with respect to other examples (or one or more aspects thereof) shown or described herein.

In the event of inconsistent usages between this document and any documents so incorporated by reference, the usage in this document controls. In this document, the terms “including” and “in which” are used as the plain-English equivalents of the respective terms “comprising” and “wherein.” Also, in the following claims, the terms “including” and “comprising” are open-ended, that is, a system, device, article, composition, formulation, or process that can include elements in addition to those listed after such a term in a claim are still deemed to fall within the scope of that claim.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” can include “A but not B,” “B but not A,” and “A and B,” unless otherwise indicated. In this document, the terms “including” and “in which” are used as the plain-English equivalents of the respective terms “comprising” and “wherein.” Also, in the following claims, the terms “including” and “comprising” are open-ended, that is, a system, article, composition, formulation, or process that can include elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

The above description is intended to be illustrative, and not restrictive. For example, the above-described examples (or one or more aspects thereof) can be used in combination with each other. Other embodiments can be used, such as by one of ordinary skill in the art upon reviewing the above description. The Abstract is provided to comply with 37 C.F.R. § 1.72(b), to allow the reader to quickly ascertain the nature of the technical disclosure. It is submitted with the understanding that it will not be used to interpret or limit the scope or meaning of the claims. Also, in the above Detailed Description, various features can be grouped together to streamline the disclosure. This should not be interpreted as intending that an unclaimed disclosed feature is essential to any claim. Rather, inventive subject matter can lie in less than all features of a particular disclosed embodiment. Thus, the following claims are hereby incorporated into the Detailed Description as examples or embodiments, with each claim standing on its own as a separate embodiment, and it is contemplated that such embodiments can be combined with each other in various combinations or permutations. The scope of the invention should be determined with reference to the appended claims, along with the full scope of equivalents to which such claims are entitled.

What is claimed is:

1. A method for characterization of latent heat of a phase change of a sample material, the method comprising:
irradiating the sample material using laser light generated by a first laser, including:
elevating a temperature of the material using the laser light; and
establishing a transition between a solid state and a liquid state; and
measuring a property of the sample material during at least one of:
a thermal arrest occurring between the solid state and the liquid state, during which the laser light is being delivered; or
the thermal arrest between liquid and solid state, during which the laser power is off or reduced.

2. The method of claim 1, comprising determining a composition of the sample material, using at least one of a value corresponding to an amount of energy delivered to the sample material by the laser light or the measured property of the sample material.

3. The method of claim 2, wherein determining the composition comprises determining a latent heat associated with a phase change of the sample material based on a temporal thermal signal corresponding with the thermal arrest and indicated by the measured at least one property.

4. The method of claim 3, wherein the latent heat associated with a phase change corresponds with an enthalpy of fusion of the sample material determined according to a thermal model.

5. The method of claim 4, wherein the thermal model is configured to, using at least one of the specified amount of energy or the measured at least one property of the sample material, calculate an operation based on an array of known temperature nodes.

6. The method of claim 5, wherein the model includes a two dimensional (2D), axisymmetric finite difference model.

7. The method of claim 2, wherein a surface included in or otherwise covering the sample material is optically reflective.

8. The method of claim 7, wherein the at least one property of the sample material comprises a measured characteristics of a beam, generated by a second laser, as reflected off a surface of the sample material.

9. The method of claim 8, wherein the transferring the specified amount of energy includes heating the sample material in the first, solid state to a temperature less than 500 Kelvin.

10. The method of claim 8, wherein the specified amount of energy is between 50 milliwatts (mW) and 200 mW.

11. The method of claim 2, comprising isolating the sample material from an ambient environment within an enclosure including establishing a fluid seal from the ambient environment.

12. The method of claim 11, wherein the at least one property of the sample material includes an indication of a temperature of the sample material versus time.

13. The method of claim 12, wherein the indication of the temperature versus time is established using an infrared pyrometer.

14. The method of claim 13, wherein the indication of the temperature versus time is established using measured infrared spectra obtained using the infrared pyrometer and measured a light intensity of specified wavelengths of visible light obtained using a visible-light pyrometer.

15. The method of claim 12, wherein the transferring the specified amount of energy includes heating the sample material in the first, solid state to a temperature greater than 1000 Kelvin (K).

16. The method of claim 12, wherein the specified amount of energy is between 1 kilowatt (kW) and 5 kW.

17. The method of claim 1, wherein the sample material is characterized at a nanoscale quantity, including the sample material having a major dimension as a small ones or tens of nanometers.

18. The method of claim 17, wherein the sample material has a thickness less than 500 nanometers (nm).

19. The method of claim 2, wherein the determining the composition of the sample material does not require use of differential scanning calorimetry.

20. A computing apparatus for characterization of latent heat of a phase change of a sample material, the computing apparatus including a processor and a memory apparatus, the memory apparatus including instructions that, when executed by the processor, cause the computing apparatus to:
irradiate the sample material using laser light generated by a laser, including:
elevating a temperature of the material using the laser light; and
establishing a transition between a solid state and a liquid state;
measure a property of the sample material during at least one of:
a thermal arrest occurring between the solid state and the liquid state, during which the laser light is being delivered; or
the thermal arrest between liquid and solid state, during which the laser power is off or reduced; and
determine a composition of the sample material, using a value corresponding to an amount of energy delivered to the sample material by the laser light or the measured property of the sample material, or both.

21. The computing apparatus of claim 20, wherein determining the composition comprises determining a latent heat associated with a phase change of the sample material based on a temporal thermal signal corresponding with the thermal arrest and indicated by the measured at least one property.

22. The computing apparatus of claim 21, wherein the latent heat associated with a phase change corresponds with an enthalpy of fusion of the sample material determined according to a thermal model.

23. The computing apparatus of claim 22, wherein the thermal model is configured to, using at least one of the specified amount of energy or the measured at least one property of the sample material, calculate an operation based on an array of known temperature nodes.

24. The computing apparatus of claim 23, wherein the model includes a two dimensional (2D), axisymmetric finite difference model.

25. The computing apparatus of claim 20, wherein a surface included in or otherwise covering the sample material is optically reflective.

26. The computing apparatus of claim 25, wherein the at least one property of the sample material comprises a measured characteristics of a beam, generated by a second laser, as reflected off a surface of the sample material.

27. The computing apparatus of claim 20, wherein the memory apparatus includes instructions that, when executed by the processor, cause the computing apparatus to isolate the sample material from an ambient environment within an enclosure including establishing a fluid seal from the ambient environment.

28. The computing apparatus of claim 27, wherein the at least one property of the sample material includes an indication of a temperature of the sample material versus time.

29. The computing apparatus of claim 28, wherein the indication of the temperature versus time is established using an infrared pyrometer.

30. The computing apparatus of claim 29, wherein the indication of the temperature versus time is established using measured infrared spectra obtained using the infrared pyrometer and measured a light intensity of specified wavelengths of visible light obtained using a visible-light pyrometer.

31. The computing apparatus of claim 20, wherein the sample material is characterized at a nanoscale quantity, including the sample material having a major dimension as a small ones or tens of nanometers.

32. A apparatus for characterization of latent heat of fusion of a sample material, the apparatus including:
a first laser configured generate laser light for irradiating the sample material using laser light generated by a laser, including:
elevating a temperature of the material using the laser light; and
establishing a transition between a solid state and a liquid state;
at least one sensor configured to measure a property of the sample material during at least one of:
a thermal arrest occurring between the solid state and the liquid state, during which the laser light is being delivered; or
the thermal arrest between liquid and solid state, during which the laser power is off or reduced; and
processor circuitry configured to perform analysis of at least one of a value corresponding to an amount of energy delivered to the sample material by the laser light or the measured property of the sample material determine a composition of the sample material.

33. The apparatus of claim 32, wherein the processor circuitry is configured to determine a latent heat associated with a phase change of the sample material based on a temporal thermal signal corresponding with the thermal arrest and indicated by the measured at least one property.

34. The apparatus of claim 33, wherein the latent heat associated with a phase change corresponds with an enthalpy of fusion of the sample material determined according to a thermal model.

35. The apparatus of claim 34, wherein the thermal model is configured to, using at least one of the specified amount of energy or the measured at least one property of the sample material, calculate an operation based on an array of known temperature nodes.

36. The apparatus of claim 32, comprising an optically reflective surface configured to cover the sample material during the irradiation.

37. The apparatus of claim 36, wherein the at least one property of the sample material comprises a measured characteristics of a beam, generated by a second laser, as reflected off the optically reflective surface.

38. The apparatus of claim 37, wherein the first laser is configured to heat the sample material in the first, solid state to a temperature less than 500 Kelvin.

39. The apparatus of claim 37, wherein the first laser is capable of irradiating laser light at a power between 50 milliwatts (mW) and 200 mW.

40. The apparatus of claim 32, comprising an enclosure configured to isolate the sample material from an ambient environment within, including establishing a fluid seal from the ambient environment.

41. The apparatus of claim 40, wherein the at least one property of the sample material includes an indication of a temperature of the sample material versus time.

42. The apparatus of claim 41, comprising an infrared temperature detector configured to measuring the indication of the temperature versus time is established.

43. The apparatus of claim 42, wherein the indication of the temperature versus time is established at least in part using measured infrared spectra obtained using the temperature detector.

44. The apparatus of claim 41, wherein the first laser is configured to heat the sample material in the first, solid state to a temperature greater than 1000 Kelvin (K).

45. The apparatus of claim 41, the first laser is capable of irradiating laser light at a power between 1 kilowatt (kW) and 5 kW.
